(19) United States
(12) Patent Application Publication
(10) Pub. No.: US 2025/0071721 A1
(43) Pub. Date: Feb. 27, 2025

(54) POSITIONING CONFIGURATION INFORMATION REQUEST METHOD AND APPARATUS, TARGET TERMINAL, AND NETWORK SIDE DEVICE

(71) Applicant: VIVO MOBILE COMMUNICATION CO., LTD., Dongguan (CN)

(72) Inventors: Xiang PAN, Dongguan (CN); Hongping ZHANG, Dongguan (CN); Yuanyuan WANG, Dongguan (CN)

(73) Assignee: VIVO MOBILE COMMUNICATION CO., LTD., Dongguan (CN)

(21) Appl. No.: 18/942,887

(22) Filed: Nov. 11, 2024

Related U.S. Application Data
(63) Continuation of application No. PCT/CN2023/099913, filed on Jun. 13, 2023.

(51) Int. Cl. H04W 64/00; H04L 5/00

(52) U.S. Cl. CPC H04W 64/00; H04L 5/0051

(57) ABSTRACT

A positioning configuration information request method and a terminal are provided. The positioning configuration information request method includes: transmitting, by a target terminal, a first request to a first network side device. The first request is used for requesting the first network side device to configure first Positioning Reference Signal (PRS) configuration information or a first PRS transmission resource. The first PRS configuration information or the first PRS transmission resource is used for Sidelink positioning. The positioning configuration information request method further includes receiving, by the target terminal, a first response from the first network side device. The first response includes the first PRS configuration information or the first PRS transmission resource.

### CROSS-REFERENCE TO RELATED APPLICATION

This application is a continuation of International Application No. PCT/CN2023/099913, filed on Jun. 13, 2023, which claims priority to Chinese Patent Application No. 202210514459.8, filed on May 11, 2022. The entire contents of each of the above-referenced applications are expressly incorporated herein by reference.

### TECHNICAL FIELD

This application belongs to the technical field of communications, and particularly relates to a positioning configuration information request method and apparatus, a target terminal, and a network side device.

### BACKGROUND

The 5th Generation Mobile Communication Technology (5G) R18 has planned to study the problem of Sidelink (SL) positioning to satisfy positioning requirements of Vehicle to Everything (V2X), Public Safety and other scenarios. Usually, Sidelink positioning involves the steps of positioning capability interaction, Positioning Reference Signal (PRS) configuration interaction, assistance information interaction, PRS measurement, measurement result reporting, positioning result calculation, etc., among which, PRS configuration usually has a great impact on Sidelink positioning accuracy.

### SUMMARY

Embodiments of this application provide a positioning configuration information request method and apparatus, a target terminal, and a network side device.

According to a first aspect, provided is a positioning configuration information request method, including:
transmitting, by a target terminal, a first request to a first network side device, where the first request is used for requesting the first network side device to configure first PRS configuration information and/or a first PRS transmission resource, and the first PRS configuration information and/or the first PRS transmission resource are/is used for Sidelink positioning; and
receiving, by the target terminal, a first response from the first network side device, where the first response includes the first PRS configuration information and/or the first PRS transmission resource.

According to a second aspect, provided is a positioning configuration information request method, including:
receiving, by a first network side device, a first request from a target terminal, where the first request is used for requesting the first network side device to configure first PRS configuration information and/or a first PRS transmission resource, and the first PRS configuration information and/or the first PRS transmission resource are/is used for Sidelink positioning; and
transmitting, by the first network side device, a first response to the target terminal based on the first request, where the first response includes the first PRS configuration information and/or the first PRS transmission resource.

According to a third aspect, provided is a positioning configuration information request method, including:
receiving, by a second network side device, a second request from a first network side device, where the second request is used for requesting the second network side device to configure second PRS configuration information and/or a second PRS transmission resource, and the second PRS configuration information and/or the second PRS transmission resource are/is used for Sidelink positioning; and
transmitting, by the second network side device, a second response to the first network side device based on the second request, where the second response includes the second PRS configuration information and/or the second PRS transmission resource.

According to a fourth aspect, provided is a positioning configuration information request apparatus, including:
a first transmitting module, configured to transmit a first request to a first network side device, where the first request is used for requesting the first network side device to configure first PRS configuration information and/or a first PRS transmission resource, and the first PRS configuration information and/or the first PRS transmission resource are/is used for Sidelink positioning; and
a first receiving module, configured to receive a first response from the first network side device, where the first response includes the first PRS configuration information and/or the first PRS transmission resource.

According to a fifth aspect, provided is a positioning configuration information request apparatus, including:
a second receiving module, configured to receive a first request from a target terminal, where the first request is used for requesting a first network side device to configure first PRS configuration information and/or a first PRS transmission resource, and the first PRS configuration information and/or the first PRS transmission resource are/is used for Sidelink positioning; and
a second transmitting module, configured to transmit a first response to the target terminal based on the first request, where the first response includes the first PRS configuration information and/or the first PRS transmission resource.

According to a sixth aspect, provided is a positioning configuration information request apparatus, including:
a third receiving module, configured to receive a second request from a first network side device, where the second request is used for requesting a second network side device to configure second PRS configuration information and/or a second PRS transmission resource, and the second PRS configuration information and/or the second PRS transmission resource are/is used for Sidelink positioning; and
a third transmitting module, configured to transmit a second response to the first network side device based on the second request, where the second response includes the second PRS configuration information and/or the second PRS transmission resource.

According to a seventh aspect, provided is a target terminal, including a processor and a memory, where the memory stores a program or instruction runnable on the processor, and the program or instruction, when executed by the processor, implements steps of the method according to the first aspect.

According to an eighth aspect, provided is a target terminal, including a processor and a communication interface, where the communication interface is configured to transmit a first request to a first network side device, where the first request is used for requesting the first network side device to configure first PRS configuration information and/or a first PRS transmission resource, and the first PRS configuration information and/or the first PRS transmission resource are/is used for Sidelink positioning; and the communication interface is further configured to receive a first response from the first network side device, where the first response includes the first PRS configuration information and/or the first PRS transmission resource.

According to a ninth aspect, provided is a first network side device, including a processor and a memory, where the memory stores a program or instruction runnable on the processor, and the program or instruction, when executed by the processor, implements steps of the method according to the second aspect.

According to a tenth aspect, provided is a first network side device, including a processor and a communication interface, where the communication interface is configured to receive a first request from a target terminal, where the first request is used for requesting the first network side device to configure first PRS configuration information and/or a first PRS transmission resource, and the first PRS configuration information and/or the first PRS transmission resource are/is used for Sidelink positioning; and the communication interface is further configured to transmit a first response to the target terminal based on the first request, where the first response includes the first PRS configuration information and/or the first PRS transmission resource.

According to an eleventh aspect, provided is a second network side device, including a processor and a memory, where the memory stores a program or instruction runnable on the processor, and the program or instruction, when executed by the processor, implements steps of the method according to the third aspect.

According to a twelfth aspect, provided is a second network side device, including: a processor and a communication interface, where the communication interface is configured to receive a second request from a first network side device, where the second request is used for requesting the second network side device to configure second PRS configuration information and/or a second PRS transmission resource, and the second PRS configuration information and/or the second PRS transmission resource are/is used for Sidelink positioning; and the communication interface is further configured to transmit a second response to the first network side device based on the second request, where the second response includes the second PRS configuration information and/or the second PRS transmission resource.

According to a thirteenth aspect, provided is a positioning configuration information request system, including: a target terminal, a first network side device, and a second network side device, where the target terminal may be configured to execute steps of the method according to the first aspect, the first network side device may be configured to execute steps of the method according to the second aspect, and the second network side device may be configured to execute steps of the method according to the third aspect.

According to a fourteenth aspect, provided is a readable storage medium is provided, where the readable storage medium stores a program or instruction, the program or instruction, when executed by a processor, implements steps of the method according to the first aspect, or implements steps of the method according to the second aspect, or implements steps of the method according to the third aspect.

According to a fifteenth aspect, provided is a chip, including a processor and a communication interface, where the communication interface is coupled to the processor, and the processor is configured to run a program or instruction to implement the method according to the first aspect, or implement the method according to the second aspect, or implement the method according to the third aspect.

According to a sixteenth aspect, provided is a computer program/program product, being stored in a storage medium, where the computer program/program product is executed by at least one processor to implement steps of the method according to the first aspect, or implement steps of the method according to the second aspect, or implement steps of the method according to the third aspect.

In embodiments of this application, since the first PRS configuration information and/or the first PRS transmission resource requested by the target terminal are/is used by the target terminal for Sidelink positioning, the received first PRS configuration information and/or first PRS transmission resource satisfy/satisfies positioning requirements of the target terminal, and the target terminal carries out positioning based on the first PRS configuration information and/or the first PRS transmission resource satisfying the positioning requirements of the target terminal, such that the positioning accuracy of Sidelink by the target terminal can be effectively improved.

### BRIEF DESCRIPTION OF THE DRAWINGS

FIG. 1 is a schematic diagram of a wireless communication system to which embodiments of this application are applicable;

FIG. 2 is a first schematic flow chart of a positioning configuration information request method according to an embodiment of this application;

FIG. 3 is a second schematic flow chart of the positioning configuration information request method according to an embodiment of this application;

FIG. 4 is a third schematic flow chart of a positioning configuration information request method according to embodiment of this application;

FIG. 5 is a first signaling interaction diagram of the positioning configuration information request method according to an embodiment of this application;

FIG. 6 is a second signaling interaction diagram of the positioning configuration information request method according to an embodiment of this application;

FIG. 7 is a third signaling interaction diagram of the positioning configuration information request method according to an embodiment of this application;

FIG. 8 is a first schematic structural diagram of a positioning configuration information request apparatus according to an embodiment of this application;

FIG. 9 is a second schematic structural diagram of a positioning configuration information request apparatus according to an embodiment of this application;

FIG. 10 is a third schematic structural diagram of a positioning configuration information request apparatus according to an embodiment of this application;

FIG. 11 is a schematic structural diagram of a communication device according to an embodiment of this application;

FIG. 12 is a schematic structural diagram of a target terminal according to an embodiment of this application;

FIG. 13 is a schematic structural diagram of a first network side device according to an embodiment of this application; and

FIG. 14 is a schematic structural diagram of a second network side device according to an embodiment of this application.

### DETAILED DESCRIPTION

The technical solutions in embodiments of this application are clearly described in the following with reference to the accompanying drawings in the embodiments of this application. Apparently, the described embodiments are merely some rather than all of the embodiments of this application. All other embodiments obtained by persons of ordinary skills based on the embodiments of this application fall within the protection scope of this application.

In the specification and claims of this application, terms “first” and “second” are used to distinguish similar objects, but are unnecessarily used to describe a specific sequence or order. It is to be understood that terms used in this way are exchangeable in a proper case, so that the embodiments of this application can be implemented in an order different from the order shown or described herein, and the objects distinguished by “first” and “second” are usually of one type, and there is no limit to the number of objects, for example, the first object may be one or more than one. In addition, “and/or” used in the specification and the claims represents at least one of the connected objects, and the character “/” generally indicates an “or” relationship between the objects associated in the context.

It is to be noted that the technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” are often used interchangeably in the embodiments of this application, and the technologies described may be used for both the systems and radio technologies mentioned above, as well as for other systems and radio technologies. The following description describes a New Radio (NR) system for exemplary purposes and uses the term NR for much of the following description, however, these technologies may also be used in communication systems other than applications of the NR system, such as 6th Generation (6G) communication systems.

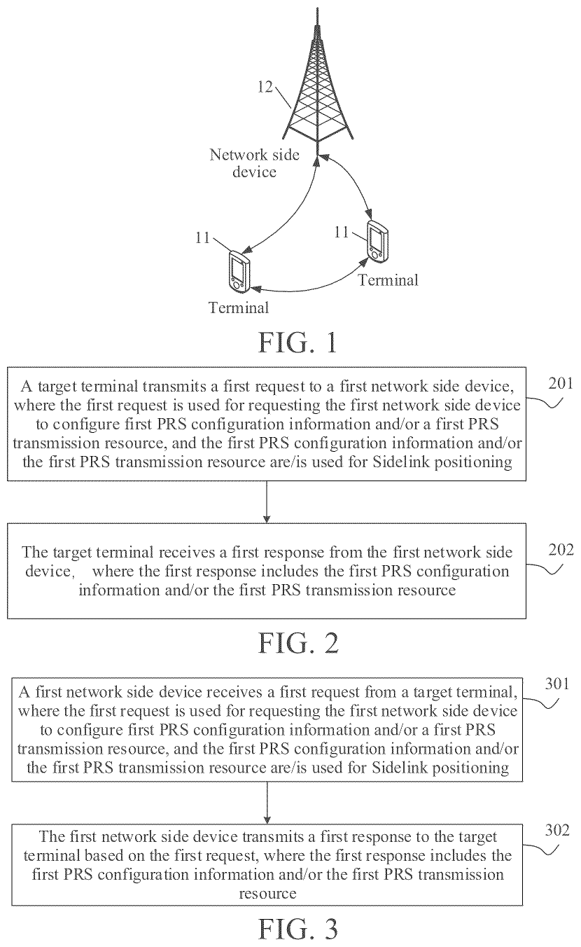

FIG. 1 is a structural diagram of a wireless communication system to which embodiments of this application are applicable, and the wireless communication system shown in FIG. 1 includes a terminal 11 and a network side device 12. The terminal 11 may be a mobile phone, a tablet personal computer, a laptop computer or a notebook computer, a Personal Digital Assistant (PDA), a palmtop, a netbook, an Ultra-Mobile Personal Computer (UMPC), a Mobile Internet Device (MID), an Augmented Reality (AR)/Virtual Reality (VR) device, a robot, a wearable device, or Vehicle User Equipment (VUE), Pedestrian User Equipment (PUE), a smart home device (a home device with a wireless communication function, such as a refrigerator, a television set, a washing machine, or furniture), a game machine, a Personal Computer (PC), a teller machine or a self-service machine or other terminal side devices. The wearable device includes: smart watches, smart bracelets, smart headphones, smart glasses, smart jewelry (smart bracelets, smart brace laces, smart rings, smart necklaces, smart leglets, smart anklets, etc.), smart wristbands, smart clothing, and the like. It is to be noted that the specific type of the terminal 11 is not limited in the embodiments of this application.

The network side device 12 may include an access network device or a core network device, where the access network device may also be referred to as a radio access network device, a Radio Access Network (RAN), a radio access network function, or a radio access network unit. The access network device may include a base station, a WLAN access point or a WiFi node or the like, the base station may be referred to as a Node B, an Evolved Node B (eNB), an access point, a Base Transceiver Station (BTS), a radio base station, a radio transceiver, a Basic Service Set (BSS), an Extended Service Set (ESS), a Home Node B, a Home Evolved Node B, a Transmission and Reception Point (TRP) or some other suitable terms in the field as long as the same technical effect is achieved, and the base station is not limited to a specific technical word, it is to be noted that: a base station in the NR system is described as an example only in the embodiments of this application, but the specific type of the base station is not limited.

A positioning configuration information request method provided by an embodiment of this application is described in detail below by means of some embodiments and application scenarios thereof in conjunction with the attached drawings.

The positioning configuration information request method provided by the embodiment of this application may be applied to a target terminal. FIG. 2 is a first schematic flow chart of a positioning configuration information request method provided by an embodiment of this application. As shown in FIG. 2, the method includes step 201 and step 202.

Step 201: A target terminal transmits a first request to a first network side device. The first request is used for requesting the first network side device to configure first PRS configuration information and/or a first PRS transmission resource. The first PRS configuration information and/or the first PRS transmission resource are/is used for Sidelink positioning.

For example, the target terminal transmits the first request to the first network side device, where the first request may be carried in a UEAssistanceInformation message or SidelinkUEInformationNR message transmitted by the target terminal to the first network side device, the first request is used for requesting the first network side device to configure the first PRS configuration information and/or the first PRS transmission resource for the target terminal and/or a reference terminal, and the first PRS configuration information and/or the first PRS transmission resource are/is used for Sidelink positioning.

In some embodiments, the target terminal may transmit, before it has a positioning requirement, the first request to the first network side device, or may transmit, after it has the positioning requirement, the first request to the first network side device.

Step 202: The target terminal receives a first response from the first network side device. The first response includes the first PRS configuration information and/or the first PRS transmission resource.

For example, the target terminal receives the first response from the first network side device, where the first request may be carried in a Radio Resource Control (RRC) Reconfiguration message, the first response includes the first PRS configuration information and/or the first PRS transmission resource, and the first PRS configuration information and/or the first PRS transmission resource are/is used for configuring the target terminal.

It will be appreciated that the target terminal, after receiving the first response from the first network side device, configures itself based on the first PRS configuration information and/or the first PRS transmission resource, and after the configuration is completed, the target terminal transmits an RRC Reconfig Complete message to the first network side device.

In the positioning configuration information request method provided by the embodiment of this application, since the first PRS configuration information and/or the first PRS transmission resource requested by the target terminal are/is used by the target terminal for Sidelink positioning, the received first PRS configuration information and/or first PRS transmission resource satisfy/satisfies positioning requirements of the target terminal, and based on the first PRS configuration information and/or the first PRS transmission resource satisfying the positioning requirements of the target terminal, the target terminal carries out positioning, such that the positioning accuracy of the target terminal for Sidelink can be effectively improved.

In some embodiments, the first request may include at least one of the following:

(1) A positioning Quality of Service (QoS) list of the target terminal.

For example, the positioning QoS list of the target terminal may correspond to one or more positioning QoS, and the positioning QoS may include at least one of the following: positioning accuracy; and a positioning delay requirement.

(2) A movement status of the target terminal.

For example, the movement status of the target terminal may include at least one of the following: a movement speed of the target terminal; and a direction of movement of the target terminal.

(3) A measurement result of the target terminal.

For example, the measurement result of the target terminal may include at least one of the following: a measurement result of Reference Signal Received Power (RSRP) of a serving cell and/or a neighboring cell; and a RSRP measurement result of the reference terminal.

The RSRP measurement result of the serving cell and/or the neighboring cell may be Synchronization Signal Block-Reference Signal Received Power (SSB-RSRP) of the base station, and a measurement result of the base station is associated with a base station identification (ID) which is, for example, a cell ID.

The RSRP measurement result of the reference terminal may be Sidelink-Reference Signal Received Power (SL-RSRP) or may be Sidelink Discovery Reference Signal Received Power (SD-RSRP). The measurement result of the reference terminal is associated with a reference terminal ID, which is, for example, a layer2 ID.

(4) A request for requesting PRS configuration information of the target terminal.

(5) A request for requesting a configuration ID list of the target terminal.

(6) A request for requesting a number of the reference terminal.

(7) A request for requesting position information of the reference terminal.

(8) A request for requesting an ID of the reference terminal.

(9) A request for requesting PRS configuration information of the reference terminal.

(10) A request for requesting a configuration ID list of the reference terminal.

For example, the PRS configuration information of the reference terminal may include at least one of the following:

(1) A PRS transmission frequency of the reference terminal.

(2) A PRS type of the reference terminal.

For example, the PRS type of the reference terminal may include at least one of the following: a periodic PRS; a semi-static PRS; and a non-periodic PRS.

(3) A PRS transmission periodicity of the reference terminal.

(4) A number of symbols within the PRS transmission periodicity of the reference terminal.

(5) Gap between the symbols within the PRS transmission periodicity of the reference terminal.

(6) A number of the PRS transmission periodicity of the reference terminal.

(7) A PRS transmission bandwidth of the reference terminal.

(8) A number of repetitions within the PRS transmission bandwidth of the reference terminal.

(9) PRS transmission start time and duration time of the reference terminal.

(10) A PRS transmission comb-type size in the frequency domain of the reference terminal.

For example, the PRS configuration information of the target terminal may include at least one of the following:

(1) A PRS transmission frequency of the target terminal.

(2) A PRS type of the target terminal.

(3) A PRS transmission periodicity of the target terminal.

(4) A number of symbols within the PRS transmission periodicity of the target terminal.

(5) Gap between the symbols within the PRS transmission periodicity of the target terminal.

(6) A number of the PRS transmission periodicity of the target terminal.

(7) A PRS transmission bandwidth of the target terminal.

(8) A number of repetitions within the PRS transmission bandwidth of the target terminal.

(9) PRS transmission start time and duration time of the target terminal.

(10) A PRS transmission comb-type size in the frequency domain of the target terminal.

In some embodiments, the first PRS configuration information may include at least one of the following:

(1) The position information of the reference terminal.

For example, the position information of the reference terminal may be longitude and latitude information of the reference terminal.

(2) The ID of the reference terminal.

For example, the ID of the reference terminal may be the layer2 ID.

(3) The PRS configuration information of the reference terminal.

(4) The configuration ID list of the reference terminal.

(5) The PRS configuration information of the target terminal.

(6) The configuration ID list of the target terminal.

In some embodiments, the first PRS transmission resource may include at least one of the following:

(1) A bandwidth of the PRS transmission resource.

(2) Initial frequency information of the PRS transmission resource.

For example, the initial frequency information of the PRS transmission resource is, for example, point A.

(3) Start time of the PRS transmission resource.

For example, the start time of the PRS transmission resource is, for example, a start symbol or a start slot.

(4) Termination time of the PRS transmission resource.

For example, the termination time of the PRS transmission resource is, for example, a termination symbol or a termination slot.

(5) Duration time of the PRS transmission resource.

For example, the duration time of the PRS transmission resource is, for example, a duration symbol or a duration slot.

(6) A periodicity of the PRS transmission resource.

(7) An associated resource pool ID of the PRS transmission resource.

In some embodiments, the first response may also include at least one of the following:

(1) A PRS transmission activation indication of the reference terminal, used for indicating whether PRS transmission of the reference terminal needs to be activated.

(2) A PRS transmission activation indication of the target terminal, used for indicating whether PRS transmission of the target terminal needs to be activated.

(3) Failure information corresponding to the first request.

For example, the failure information includes at least one of the following:
a. at least one parameter included in the first request being incapable of being satisfied;
b. at least one parameter included in the first request being incapable of being satisfied, and an allowable range of values for the parameter being incapable of being satisfied; and
c. the first network side device not supporting the first request.

In some embodiments, in a case that the PRS transmission activation indication of the reference terminal is used for indicating that the PRS transmission of the reference terminal needs to be activated, the target terminal transmits a first activation request to the first network side device, where the first activation request is used for requesting to activate the PRS transmission of the reference terminal.

In some embodiments, in a case that the PRS transmission activation indication of the target terminal is used for indicating that the PRS transmission of the target terminal needs to be activated, the target terminal transmits a second activation request to the first network side device, where the second activation request is used for requesting to activate the PRS transmission of the target terminal.

For example, in a case that the PRS transmission activation indication of the reference terminal is used for indicating that the PRS transmission of the reference terminal needs to be activated, that is, in a case that the PRS transmission of the reference terminal needs to be activated, the target terminal transmits the first activation request to the first network side device to request the first network side device to activate the PRS transmission of the reference terminal.

In a case that the PRS transmission activation indication of the target terminal is used for indicating that the PRS transmission of the target terminal needs to be activated, that is, in a case that the PRS transmission of the target terminal needs to be activated, the target terminal transmits the second activation request to the first network side device to request the first network side device to activate the PRS transmission of the target terminal.

The activation request may include a Medium Access Control-Control Element (MAC CE), or Uplink Control Information (UCI).

In some embodiments, whether the PRS transmission of the reference terminal needs to be activated may also be implicitly indicated by the PRS type of the reference terminal. For example, in a case that the PRS type of the reference terminal is the periodic PRS, it is indicated that the PRS transmission of the reference terminal does not need to be activated. In a case that the PRS type of the reference terminal is the semi-static PRS or the non-periodic PRS, it is indicated that the PRS transmission of the reference terminal needs to be activated.

In a case that the PRS type of the reference terminal is the semi-static PRS or the non-periodic PRS, that is, it is indicated that in a case that the PRS transmission of the reference terminal needs to be activated, the target terminal transmits the first activation request to the first network side device to request the first network side device to activate the PRS transmission of the reference terminal.

Similarly to the reference terminal, whether the PRS transmission of the target terminal needs to be activated may also be implicitly indicated by the PRS type of the target terminal. For example, in a case that the PRS type of the target terminal is the periodic PRS, it is indicated that the PRS transmission of the target terminal does not need to be activated. In a case that the PRS type of the target terminal is the semi-static PRS or the non-periodic PRS, it is indicated that the PRS transmission of the target terminal needs to be activated.

In a case that the PRS type of the target terminal is the semi-static PRS or the non-periodic PRS, that is, it is indicated that in a case that the PRS transmission of the target terminal needs to be activated, the target terminal transmits the second activation request to the first network side device to request the first network side device to activate the PRS transmission of the target terminal.

In some embodiments, before the target terminal transmits the first request to the first network side device, the target terminal receives a first indication from the first network side device. The first indication is used for indicating that the first network side device allows the target terminal to transmit the first request.

For example, the target terminal receives the first indication from the first network side device, where the first indication may be carried in a broadcast message or a dedicated message from the first network side device, the broadcast message is, for example, a System Information Block (SIB)12 message, the dedicated message is, for example, an RRCReconfiguration message, and the first indication is used for indicating that the target terminal may transmit the first request to the first network side device.

It will be appreciated that if the target terminal transmits the first request to the first network side device before receiving the first indication from the first network side device, the first response received by the target terminal from the first network side device may include the failure information corresponding to the first request, and the failure information may be: the first network side device not supporting the first request.

In some embodiments, the first indication may include at least one of the following:

(1) Allowing the target terminal to transmit the first request.

(2) Duration of a first timer.

For example, the target terminal may be set to start the first timer after transmitting the first request, and the target terminal is set not to be allowed to transmit the first request again before the first timer times out.

(3) A number of a reference terminal that is capable of requesting configuration.

(4) PRS configuration information of the reference terminal that is capable of requesting configuration.

(5) A configuration list of the reference terminal that is capable of requesting configuration. The configuration list of the reference terminal includes: a configuration ID of the reference terminal, and/or PRS configuration information of the reference terminal.

For example, the PRS configuration information of the reference terminal may be explicitly indicated in the first indication or may be specified by a protocol.

(6) PRS configuration information of a target terminal that is capable of requesting configuration.

(7) A configuration list of the target terminal that is capable of requesting configuration. The configuration list of the target terminal includes: a configuration ID of the target terminal, and/or PRS configuration information of the target terminal.

For example, the PRS configuration information of the target terminal may be explicitly indicated in the first indication or may be specified by a protocol.

In some embodiments, after the target terminal receives the first response from the first network side device, the target terminal measures a PRS of the reference terminal based on the first response to obtain a first PRS measurement result. The target terminal calculates a positioning result of the target terminal based on the first PRS measurement result.

The first PRS measurement result may include at least one of the following:

(1) A Reference Signal Time Difference (Reference Signal Time Difference, RSTD) measurement result.

(2) A Round-Trip Time (RTT) measurement result.

(3) An Angle Of Arrival (AOA) measurement result.

(4) An Angle Of Departure (AOD) measurement result.

(5) RSRP.

For example, the target terminal first measures the PRS of the reference terminal based on the first response to obtain the first PRS measurement result, and then may calculate the positioning result of the target terminal directly according to the first PRS measurement result of the reference terminal.

In some embodiments, the target terminal receives a second PRS measurement result from the reference terminal. The second PRS measurement result is a measurement result obtained by the reference terminal measuring, based on the first response, a PRS of the target terminal.

That the target terminal calculates a positioning result of the target terminal based on the first PRS measurement result, includes: the target terminal calculates the positioning result of the target terminal based on the first PRS measurement result and the second PRS measurement result, where the second PRS measurement result may include at least one of the following:

(1) An RSTD measurement result.

(2) An RTT measurement result.

(3) An AOA measurement result.

(4) An AOD measurement result.

(5) RSRP.

For example, the target terminal measures the PRS of the reference terminal based on the first response to obtain the first PRS measurement result; the target terminal also receives the second PRS measurement result from the reference terminal, and the second PRS measurement result is a measurement result obtained by the reference terminal measuring, based on the first response, the PRS of the target terminal; and then the target terminal may calculate the positioning result of the target terminal by combining the first PRS measurement result of the reference terminal and the second PRS measurement result of the target terminal.

In the embodiment of this application, the target terminal combines the first PRS measurement result of the reference terminal and the second PRS measurement result of the target terminal to calculate the positioning result of the target terminal, such that compared with the case where the target terminal calculates, only based on the first PRS measurement result of the reference terminal, the positioning result of the target terminal, the obtained positioning result of the target terminal is more accurate, that is, the positioning accuracy of the target terminal for Sidelink is improved.

The positioning configuration information request method provided by the embodiment of this application may also be applied to a first network side device. FIG. 3 is a second schematic flow chart of the positioning configuration information request method provided by an embodiment of this application. As shown in FIG. 3, the method includes step 301 to step 303.

Step 301: A first network side device receives a first request from a target terminal. The first request is used for requesting the first network side device to configure first PRS configuration information and/or a first PRS transmission resource. The first PRS configuration information and/or the first PRS transmission resource are/is used for Sidelink positioning.

For example, the first network side device receives the first request from the target terminal, where the first request may be carried in a UEAssistanceInformation message or SidelinkUEInformationNR message transmitted by the target terminal to the first network side device, the first request is used for requesting the first network side device to configure the first PRS configuration information and/or the first PRS transmission resource for the target terminal and/or a reference terminal, and the first PRS configuration information and/or the first PRS transmission resource are/is used for Sidelink positioning.

Step 302: The first network side device transmits a first response to the target terminal based on the first request. The first response includes the first PRS configuration information and/or the first PRS transmission resource.

For example, the first network side device transmits the first response to the target terminal, where the first request may be carried in an RRCReconfiguration message, the first response includes the first PRS configuration information and/or the first PRS transmission resource, and the first PRS configuration information and/or the first PRS transmission resource are/is used for configuring the target terminal.

It will be appreciated that the target terminal, after receiving the first response from the first network side device, configures itself based on the first PRS configuration information and/or the first PRS transmission resource, and after the configuration of the target terminal is completed, the first network side device will receive an RRC Reconfig Complete message from the target terminal.

In some embodiments, the first request may include at least one of the following:

(1) A positioning QoS list of the target terminal;

(2) A movement status of the target terminal.

(3) A measurement result of the target terminal.

(4) A request for requesting PRS configuration information of the target terminal.

(5) A request for requesting a configuration ID list of the target terminal.

(6) A request for requesting a number of the reference terminal.

(7) A request for requesting position information of the reference terminal.

(8) A request for requesting an ID of the reference terminal.

(9) A request for requesting PRS configuration information of the reference terminal.

(10) A request for requesting a configuration ID list of the reference terminal.

For example, the PRS configuration information of the reference terminal may include at least one of the following:

(1) A PRS transmission frequency of the reference terminal.

(2) A PRS type of the reference terminal.

For example, the PRS type of the reference terminal may include at least one of the following: a periodic PRS; a semi-static PRS; and a non-periodic PRS.

(3) A PRS transmission periodicity of the reference terminal.

(4) A number of symbols within the PRS transmission periodicity of the reference terminal.

(5) Gap between the symbols within the PRS transmission periodicity of the reference terminal.

(6) A number of the PRS transmission periodicity of the reference terminal.

(7) A PRS transmission bandwidth of the reference terminal.

(8) A number of repetitions within the PRS transmission bandwidth of the reference terminal.

(9) PRS transmission start time and duration time of the reference terminal.

(10) A PRS transmission comb-type size in the frequency domain of the reference terminal.

For example, the PRS configuration information of the target terminal may include at least one of the following:

(1) A PRS transmission frequency of the target terminal.

(2) A PRS type of the target terminal.

(3) A PRS transmission periodicity of the target terminal.

(4) A number of symbols within the PRS transmission periodicity of the target terminal.

(5) Gap between the symbols within the PRS transmission periodicity of the target terminal.

(6) A number of the PRS transmission periodicity of the target terminal.

(7) A PRS transmission bandwidth of the target terminal.

(8) A number of repetitions within the PRS transmission bandwidth of the target terminal.

(9) PRS transmission start time and duration time of the target terminal.

(10) A PRS transmission comb-type size in the frequency domain of the target terminal.

In some embodiments, the first PRS configuration information may include at least one of the following:

(1) The position information of the reference terminal.

(2) The ID of the reference terminal.

(3) The PRS configuration information of the reference terminal.

(4) The configuration ID list of the reference terminal.

(5) The PRS configuration information of the target terminal.

(6) The configuration ID list of the target terminal.

In some embodiments, the first PRS transmission resource may include at least one of the following:

(1) A bandwidth of the PRS transmission resource.

(2) Initial frequency information of the PRS transmission resource.

(3) Start time of the PRS transmission resource.

(4) Termination time of the PRS transmission resource.

(5) Duration time of the PRS transmission resource.

(6) A periodicity of the PRS transmission resource.

(7) An associated resource pool ID of the PRS transmission resource.

In some embodiments, the first response also includes at least one of the following:

(1) A PRS transmission activation indication of the reference terminal, used for indicating whether PRS transmission of the reference terminal needs to be activated.

(2) A PRS transmission activation indication of the target terminal, used for indicating whether PRS transmission of the target terminal needs to be activated.

(3) Failure information corresponding to the first request.

For example, the failure information may include at least one of the following:
a. at least one parameter included in the first request being incapable of being satisfied;
b. at least one parameter included in the first request being incapable of being satisfied, and an allowable range of values for the parameter being incapable of being satisfied; and
c. the first network side device not supporting the first request.

In some embodiments, before receiving the first request from the target terminal, the first network side device transmits a first indication to the target terminal. The first indication is used for indicating that the first network side device allows the target terminal to transmit the first request.

For example, the first network side device transmits the first indication to the target terminal, where the first indication may be carried in a broadcast message or a dedicated message transmitted by the first network side device, the broadcast message is, for example, an SIB12 message, the dedicated message is, for example, an RRCReconfiguration message, and the first indication is used for indicating that the target terminal may transmit the first request to the first network side device.

In some embodiments, the first indication may include at least one of the following:

(1) Allowing the target terminal to transmit the first request.

(2) Duration of a first timer.

(3) A number of a reference terminal that is capable of requesting configuration.

(4) PRS configuration information of the reference terminal that is capable of requesting configuration.

(5) A configuration list of the reference terminal that is capable of requesting configuration. The configuration list of the reference terminal includes: a configuration ID of the reference terminal, and/or PRS configuration information of the reference terminal.

(6) PRS configuration information of a target terminal that is capable of requesting configuration.

(7) A configuration list of the target terminal that is capable of requesting configuration. The configuration list of the target terminal includes: a configuration ID of the target terminal, and/or PRS configuration information of the target terminal.

In some embodiments, after the first network side device determines the first PRS configuration information and/or the first PRS transmission resource based on the first request, the first network side device transmits the first configuration to the reference terminal. The first configuration includes the first PRS configuration information and/or the first PRS transmission resource.

For example, the first network side device, after determining the first PRS configuration information and/or the first PRS transmission resource, transmits a first configuration to the reference terminal, and the first configuration includes the first PRS configuration information and/or the first PRS transmission resource, such that the reference terminal configures itself based on the first PRS configuration information and/or the first PRS transmission resource.

It will be appreciated that the reference terminal, after receiving the first configuration from the first network side device, will configure itself based on the first PRS configuration information and/or the first PRS transmission resource in the first configuration, and after the configuration is completed, the reference terminal transmits an RRC Reconfig Complete message to the first network side device.

In some embodiments, after the first network side device determines the first PRS configuration information and/or the first PRS transmission resource based on the first request, in a case that a serving cell of the reference terminal is different from that of the target terminal, the first network side device transmits a second request to a second network side device to which the reference terminal accesses. The second request is used for requesting the second network side device to configure second PRS configuration information and/or a second PRS transmission resource. The second PRS configuration information and/or the second PRS transmission resource are/is used for Sidelink positioning.

The first network side device receives a second response from the second network side device. The second response includes the second PRS configuration information and/or the second PRS transmission resource.

For example, in a case that the serving cell of the reference terminal is different from that of the target terminal, i.e., in a case that the serving cell of the reference terminal is not the first network side device, the first network side device transmits the second request to the second network side device to which the reference terminal accesses, so as to request the second network side device to configure the second PRS configuration information and/or the second PRS transmission resource for Sidelink positioning, the first network side device receives the second response from the second network side device, and may carry the second PRS configuration information and/or the second PRS transmission resource included in the second response in the first response for transmitting to the target terminal, and then the target terminal carries out configuration based on the second PRS configuration information and/or the second PRS transmission resource.

In some embodiments, the second request may include at least one of the following:

(1) The position information of the reference terminal.

(2) The ID of the reference terminal.

(3) The PRS configuration information of the reference terminal.

(4) The configuration ID list of the reference terminal.

(5) The PRS configuration information of the target terminal.

(6) The configuration ID list of the target terminal.

(7) A request for requesting a number of the reference terminal.

(8) A request for requesting the position information of the reference terminal.

(9) A request for requesting the ID of the reference terminal.

(10) A request for requesting the PRS configuration information of the reference terminal.

(11) A request for requesting the configuration ID list of the reference terminal.

In some embodiments, the second PRS configuration information may include at least one of the following:

(1) The position information of the reference terminal.

(2) The ID of the reference terminal.

(3) The PRS configuration information of the reference terminal.

(4) The configuration ID list of the reference terminal.

(5) Failure information corresponding to the second request.

For example, the failure information may include at least one of the following:

(1) at least one parameter included in the second request being incapable of being satisfied;

(2) at least one parameter included in the second request being incapable of being satisfied, and an allowable range of values for the parameter being incapable of being satisfied; and

(3) the second network side device not supporting the second request.

In some embodiments, the second PRS transmission resource may include at least one of the following:

(1) A bandwidth of the PRS transmission resource.

(2) Initial frequency information of the PRS transmission resource.

(3) Start time of the PRS transmission resource.

(4) Termination time of the PRS transmission resource.

(5) Duration time of the PRS transmission resource.

(6) A periodicity of the PRS transmission resource.

(7) An associated resource pool ID of the PRS transmission resource.

In the positioning configuration information request method provided by the embodiment of this application, since the first PRS configuration information and/or the first PRS transmission resource in the first request received by the first network side device are/is requested by the target terminal for Sidelink positioning, the first PRS configuration information and/or the first PRS transmission resource transmitted to the target terminal satisfies positioning requirements of the target terminal, and then based on the first PRS configuration information and/or the first PRS transmission resource satisfying the positioning requirements of the target terminal, the target terminal carries out positioning, such that the positioning accuracy of the target terminal for Sidelink can be effectively improved.

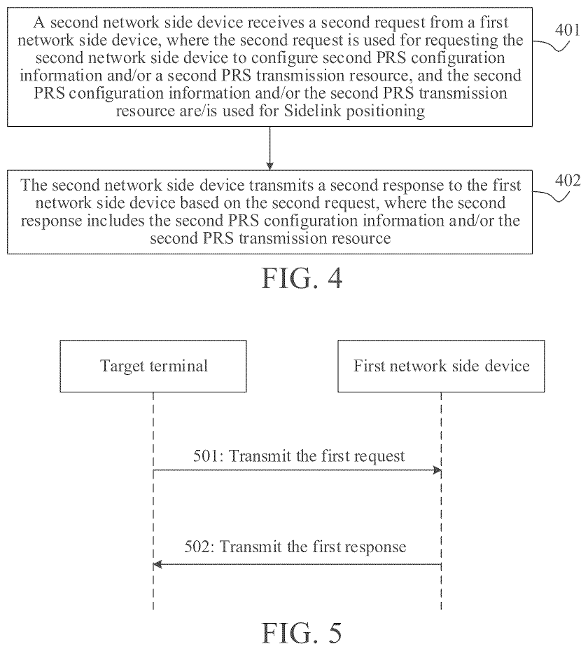

The positioning configuration information request method provided by the embodiment of this application may also be applied to a second network side device. FIG. 4 is a third schematic flow chart of the positioning configuration information request method provided by an embodiment of this application. As shown in FIG. 4, the method includes step 401 to step 403.

Step 401: A second network side device receives a second request from a first network side device. The second request is used for requesting the second network side device to configure second PRS configuration information and/or a second PRS transmission resource. The second PRS configuration information and/or the second PRS transmission resource are/is used for Sidelink positioning.

Step 402: The second network side device transmits a second response to the first network side device based on the second request. The second response includes the second PRS configuration information and/or the second PRS transmission resource.

For example, the second network side device receives the second request from the first network side device for requesting the second network side device to configure the second PRS configuration information and/or the second PRS transmission resource for the reference terminal, then the second network side device transmits the second response to the first network side device, and the second response includes the second PRS configuration information and/or the second PRS transmission resource configured for the reference terminal.

In some embodiments, the second request may include at least one of the following:

(1) Position information of the reference terminal.

(2) An ID of the reference terminal.

(3) PRS configuration information of the reference terminal.

(4) A configuration ID list of the reference terminal.

(5) PRS configuration information of the target terminal.

(6) A configuration ID list of the target terminal.

(7) A request for requesting a number of the reference terminal.

(8) A request for requesting position information of the reference terminal.

(9) A request for requesting the ID of the reference terminal.

(10) A request for requesting PRS configuration information of the reference terminal.

(11) A request for requesting a configuration ID list of the reference terminal.

In some embodiments, the second PRS configuration information may include at least one of the following:

(1) The position information of the reference terminal.

(2) The ID of the reference terminal.

(3) The PRS configuration information of the reference terminal.

(4) The configuration ID list of the reference terminal.

(5) Failure information corresponding to the second request.

For example, the failure information may include at least one of the following:

(1) at least one parameter included in the second request being incapable of being satisfied;

(2) at least one parameter included in the second request being incapable of being satisfied, and an allowable range of values for the parameter being incapable of being satisfied; and

(3) the second network side device not supporting the second request.

In some embodiments, the second PRS transmission resource may include at least one of the following:

(1) A bandwidth of the PRS transmission resource.

(2) Initial frequency information of the PRS transmission resource.

(3) Start time of the PRS transmission resource.

(4) Termination time of the PRS transmission resource.

(5) Duration time of the PRS transmission resource.

(6) A periodicity of the PRS transmission resource.

(7) An associated resource pool ID of the PRS transmission resource.

In some embodiments, the PRS configuration information of the reference terminal may include at least one of the following:

(1) A PRS transmission frequency of the reference terminal.

(2) A PRS type of the reference terminal.

(3) A PRS transmission periodicity of the reference terminal.

(4) A number of symbols within the PRS transmission periodicity of the reference terminal.

(5) Gap between the symbols within the PRS transmission periodicity of the reference terminal.

(6) A number of the PRS transmission periodicity of the reference terminal.

(7) A PRS transmission bandwidth of the reference terminal.

(8) A number of repetitions within the PRS transmission bandwidth of the reference terminal.

(9) PRS transmission start time and duration time of the reference terminal.

(10) A PRS transmission comb-type size in the frequency domain of the reference terminal.

In some embodiments, the PRS configuration information of the target terminal includes at least one of the following:

(1) A PRS transmission frequency of the target terminal.

(2) A PRS type of the target terminal.

(3) A PRS transmission periodicity of the target terminal.

(4) A number of symbols within the PRS transmission periodicity of the target terminal.

(5) Gap between the symbols within the PRS transmission periodicity of the target terminal.

(6) A number of the PRS transmission periodicity of the target terminal.

(7) A PRS transmission bandwidth of the target terminal.

(8) A number of repetitions within the PRS transmission bandwidth of the target terminal.

(9) PRS transmission start time and duration time of the target terminal.

(10) A PRS transmission comb-type size in the frequency domain of the target terminal.

In the positioning configuration information request method provided by the embodiment of this application, in a case that a serving cell of the reference terminal is not the same cell as a serving cell of the target terminal, the first network side device transmits the second request to the second network side device to which the reference terminal accesses, requesting the second network side device to configure the second PRS configuration information and/or the second PRS transmission resource for Sidelink positioning, so that the target terminal and/or the reference terminal can obtain PRS configuration and a Sidelink resource that satisfy the positioning accuracy requirement of the target terminal for Sidelink, and the positioning accuracy of the target terminal for Sidelink can be effectively improved.

An interaction process of the positioning configuration information request method provided by the embodiments of this application is described below in a form of signaling interaction.

FIG. 5 is a first signaling interaction diagram of the positioning configuration information request method provided by the embodiments of this application. As shown in FIG. 5, the method includes step 501 to step 503.

Step 501: The target terminal transmits the first request to the first network side device. Correspondingly, the first network side device receives the first request from the target terminal.

The first request is used for requesting the first network side device to configure the first PRS configuration information and/or the first PRS transmission resource. The first PRS configuration information and/or the first PRS transmission resource are/is used for Sidelink positioning.

Step 502: The first network side device transmits the first response to the target terminal based on the first request. Correspondingly, the target terminal receives the first response from the first network side device.

The first response includes the first PRS configuration information and/or the first PRS transmission resource.

Taking that the first network side device is a first base station, the serving cell of the reference terminal is the same as that of the target terminal, and the serving cells are both first base station devices as an example, the interaction process of the positioning configuration information request method provided by the embodiments of this application is described below.

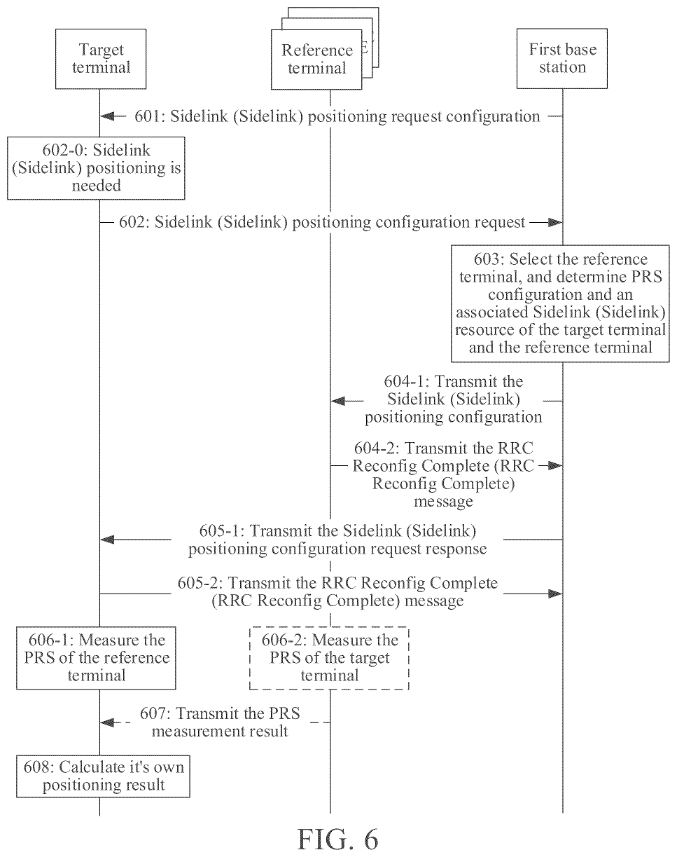

FIG. 6 is a second signaling interaction diagram of the positioning configuration information request method provided by the embodiments of this application. As shown in FIG. 6, the method includes step 601 to step 608.

Step 601: The target terminal receives a Sidelink positioning request configuration from the first base station.

For example, the target terminal may receive the first indication from the first base station via the broadcast message (e.g., the SIB12 message) or the dedicated message (e.g., the RRCReconfiguration message), where the first indication is the Sidelink positioning request configuration, used for indicating that the target terminal is allowed to transmit the first request to the first base station.

The Sidelink positioning request configuration may include at least one of the following:

(1) Allowing the target terminal to transmit a Sidelink positioning request indication.

(2) The duration of the first timer.

The target terminal may be set to start the first timer after transmitting a Sidelink positioning configuration request to the first base station, and the target terminal may be set not to be allowed to transmit the Sidelink positioning configuration request before the first timer times out.

(3) The number of the reference terminal that is capable of requesting configuration.

(4) The PRS transmission frequency of the reference terminal/target terminal that is capable of requesting configuration.

(5) The PRS type of the reference terminal/target terminal that is capable of requesting configuration.

For example, the PRS type is, for example, the periodic PRS, the semi-static PRS, or the non-periodic PRS.

(6) The PRS transmission periodicity of the reference terminal/target terminal that is capable of requesting configuration.

(7) The number of the symbols within the PRS transmission periodicity of the reference terminal/target terminal that is capable of requesting configuration.

(8) The gap between the symbols within the PRS transmission periodicity of the reference terminal/target terminal that is capable of requesting configuration.

(9) The PRS transmission bandwidth of the reference terminal/target terminal that is capable of requesting configuration.

(10) The number of the repetitions within the PRS transmission bandwidth of the reference terminal/target terminal that is capable of requesting configuration.

(11) The configuration list of the reference terminal/target terminal that is capable of requesting configuration.

For example, each configuration list may include:
a. The configuration ID of the reference terminal/target terminal.
b. The configuration of the reference terminal/target terminal.

The terminal configuration may include the PRS transmission frequency, the PRS type, the PRS transmission periodicity, the number of symbols within the PRS transmission periodicity, the gap between the symbols within the PRS transmission periodicity, the PRS transmission bandwidth and the number of repetitions within the PRS transmission bandwidth above.

The terminal configuration above may be explicitly indicated in the Sidelink positioning request configuration or may be specified by a protocol.

Step 602: The target terminal transmits the Sidelink positioning configuration request to the first base station.

For example, the target terminal transmits the first request to the first base station, where the first request is the Sidelink positioning configuration request (positioning assistance information), and may be understood as a target terminal and reference terminal configuration request, used for requesting the first base station to configure the target terminal and the reference terminal. The Sidelink positioning configuration request may be carried in the UEAssistanceInformation message or the SidelinkUEInformationNR message.

The Sidelink positioning configuration request may include one or more of the following:

(1) The positioning QoS list of the target terminal. The positioning QoS list may correspond to one or more positioning QoS, and the positioning QoS includes positioning accuracy and a positioning delay requirement.

(2) The movement status of the target terminal. The movement status may include the speed and the direction.

(3) The measurement result of the target terminal. The measurement result of the target terminal may include the RSRP measurement results of the serving cell and the neighboring cell and/or the RSRP measurement result of the reference terminal, where the reference terminal is associated with the layer2 ID.

(4) The request for the number of the reference terminal.

(5) The request for the position information of the reference terminal.

(6) The request for the ID of the reference terminal.

(7) The request for the PRS transmission frequency of the reference terminal/target terminal.

(8) The request for the PRS type of the reference terminal/target terminal. The PRS type is, for example, the periodic PRS, the semi-static PRS, and the non-periodic PRS.

(9) The request for the PRS transmission periodicity of the reference terminal/target terminal.

(10) The request for the number of symbols within the PRS transmission periodicity of the reference terminal/target terminal.

(11) The request for the gap between the symbols within the PRS transmission periodicity of the reference terminal/target terminal.

(12) The request for the number of the PRS transmission periodicity of the reference terminal/target terminal.

(13) The request for the PRS transmission bandwidth of the reference terminal/target terminal.

(14) The request for the number of repetitions within the PRS transmission bandwidth of the reference terminal/target terminal.

(15) The request for the PRS transmission start time and duration time of the reference terminal/target terminal.

(16) The request for the configuration ID list of the reference terminal/target terminal.

Before step 602, step 602-0 may be included.

Step 602-0: The target terminal needs to perform Sidelink positioning.

It will be appreciated that the target terminal may transmit the Sidelink positioning configuration request to the first base station after determining that Sidelink positioning is needed.

Step 603: The first base station selects the reference terminal based on the Sidelink positioning configuration request, and determines PRS configuration and an associated Sidelink resource of the target terminal and the reference terminal.

For example, the first base station selects the reference terminal based on the Sidelink positioning configuration request, and determines that the PRS configuration of the target terminal and the reference terminal is first PRS configuration information, and determines that the Sidelink resource associated with the target terminal and the reference terminal is a first PRS transmission resource.

Step 604-1: The first base station transmits the Sidelink positioning configuration to the selected reference terminal.

For example, the first base station transmits a first configuration to the selected reference terminal, and the first configuration is Sidelink positioning configuration.

The Sidelink positioning configuration may include one or more of the following:

(1) The PRS transmission frequency of the reference terminal/target terminal.

(2) The PRS transmission periodicity of the reference terminal/target terminal.

(3) The number of symbols within the PRS transmission periodicity of the reference terminal/target terminal.

(4) The gap between the symbols within the PRS transmission periodicity of the reference terminal/target terminal.

(5) The PRS transmission bandwidth of the reference terminal/target terminal.

(6) The number of repetitions within the PRS transmission bandwidth of the reference terminal/target terminal.

(7) The PRS transmission start time and duration time of the reference terminal/target terminal.

Step 604-2: The reference terminal transmits the RRC Reconfig Complete message to the first base station.

Step 605-1: The first base station transmits a Sidelink positioning configuration request response to the target terminal.

For example, the first base station transmits the first response to the target terminal, and the first response is the Sidelink positioning configuration request response.

The Sidelink positioning configuration request response may be transmitted via the RRCReconfiguration message, and the Sidelink positioning configuration request response may include one or more of the following:

(1) The position information of the reference terminal. The position information is, for example, the longitude and latitude information.

(2) The ID of the reference terminal. The ID of the reference terminal is, for example, the layer2 ID.

(3) The PRS transmission frequency of the reference terminal/target terminal.

(4) The PRS type of the reference terminal/target terminal. The PRS type is, for example, the periodic PRS, the semi-static PRS, and the non-periodic PRS.

(5) The PRS transmission periodicity of the reference terminal/target terminal.

(6) The number of symbols within the PRS transmission periodicity of the reference terminal/target terminal.

(7) The gap between the symbols within the PRS transmission periodicity of the reference terminal/target terminal.

(8) The PRS transmission bandwidth of the reference terminal/target terminal.

(9) The number of repetitions within the PRS transmission bandwidth of the reference terminal/target terminal.

(10) The PRS transmission start time and duration time of the reference terminal/target terminal.

(11) The configuration ID list of the reference terminal/target terminal.

(12) The PRS transmission activation indication of the reference terminal/target terminal. That is, whether PRS transmission of the configured reference terminal/target terminal needs to be activated by a request again.

In particular, whether the PRS transmission of the reference terminal/target terminal needs to be activated may be implicitly indicated by the PRS type, for example, the periodic PRS indicates that the PRS transmission does not need to be activated, and the semi-static PRS and the non-periodic PRS indicate that the PRS transmission needs to be activated.

(13) Sidelink positioning configuration request failure information.
a. Reasons for failure: Parameters of the Sidelink positioning configuration request being incapable of being satisfied; and a network not supporting the positioning configuration request.
b. A maximum/minimum supported value corresponding to the parameter of the Sidelink positioning configuration being incapable of being satisfied.

Step 605-2: The target terminal transmits the RRC Reconfig Complete message to the first base station.

Step 606-1: The target terminal measures the PRS of the reference terminal.

For example, the target terminal measures, according to the received first PRS configuration information and/or first PRS transmission resource, the PRS of the reference terminal.

Step 606-2: The reference terminal measures the PRS of the target terminal.

For example, the reference terminal measures, according to the received first PRS configuration information and/or first PRS transmission resource, the PRS of the target terminal.

It is to be noted that step 606-2 is indicated by a dashed box in the figure.

In a case that step 606-2 is selected to be executed, the following step 607 is required;
in a case that step 606-2 is not selected to be executed, that is, only step 606-1 is executed, step 607 is not required.

In particular, before the reference terminal performs the PRS measurement, the target terminal may transmit a measurement request to the reference terminal, and the measurement request may include PRS configuration information of the target terminal to request the reference terminal to measure the PRS of the target terminal.

It is further to be noted that: if the Sidelink positioning configuration request response or the Sidelink positioning configuration indicates that the PRS transmission needs to be activated, the target terminal needs to activate the PRS transmission of the reference terminal/target terminal via an MAC CE or UCI request before the PRS of the target terminal/reference terminal is measured.

Step 607: In a case that the reference terminal measures the PRS of the target terminal, the reference terminal transmits the PRS measurement result to the target terminal.

For example, the reference terminal, after measuring the PRS of the target terminal based on the received first PRS configuration information and/or first PRS transmission resource, needs to feedback the PRS measurement result to the target terminal.

The PRS measurement result may include one or more of the following, but is not limited to:

(1) The RSTD measurement result.

(2) The RTT measurement result.

(3) The AOA measurement result.

(4) The AOD measurement result.

(5) The RSRP.

It is to be noted that step 607 is indicated by a dashed arrow in the figure.

Step 608: The target terminal calculates its own positioning result based on the PRS measurement result.

For example, the target terminal may calculate its own positioning result based only on the PRS measurement result corresponding to the PRS of the reference terminal measured by the target terminal and may also calculate its own positioning result by combining the PRS measurement result corresponding to the PRS of the reference terminal measured by the target terminal and the PRS measurement result corresponding to the PRS of the target terminal measured by the reference terminal.

Taking that the first network side device is the first base station, the second network side device is the second base station, the serving cell of the reference terminal is the different from that of the target terminal, the serving cell of the target terminal is the first base station, and the serving cell of the reference terminal is the second base station as an example, an interaction process of the positioning configuration information request method provided by the embodiments of this application is described below.

The reference terminal located at the edge of the serving cell of the target terminal may have a serving cell that is not the same base station as the serving cell of the target terminal, and in this case, the base stations need to interact with each other about the configuration request information of the reference terminal.

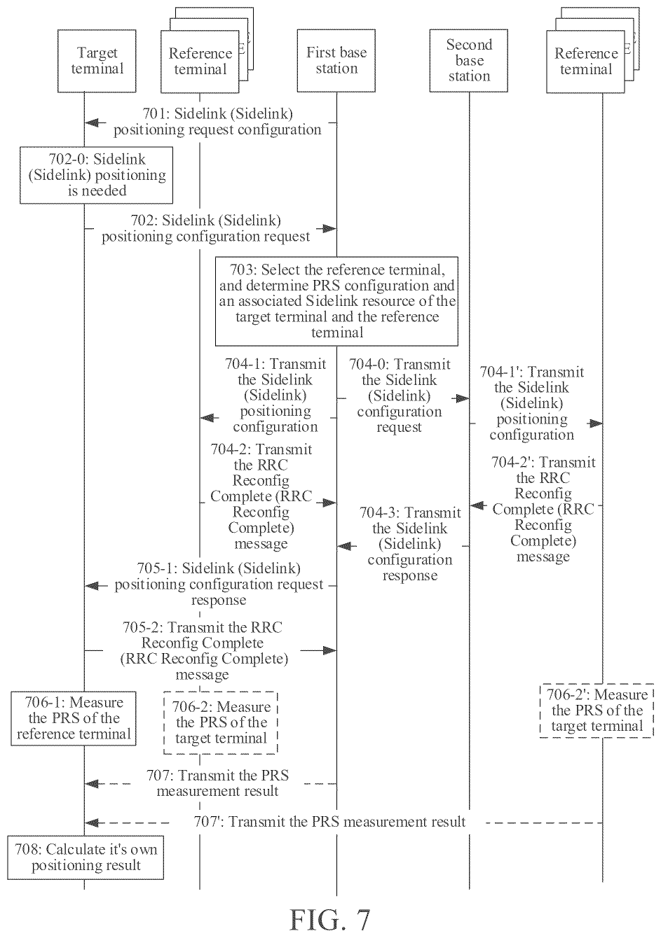

FIG. 7 is a third signaling interaction diagram of the positioning configuration information request method provided by the embodiments of this application. As shown in FIG. 7, the method includes step 701 to step 708.

Step 701: The target terminal receives the Sidelink positioning request configuration from the first base station.

Step 702: The target terminal transmits the Sidelink positioning configuration request to the first base station.

Before step 702, step 702-0 may be included.

Step 702-0: The target terminal needs to perform Sidelink positioning.

Step 703: The first base station selects the reference terminal based on the Sidelink positioning configuration request, and determines PRS configuration and an associated Sidelink resource of the target terminal and the reference terminal.

Step 704-0: The first base station transmits a Sidelink configuration request to the second base station.

For example, the first base station transmits the second request to the second base station, and the second request is the Sidelink configuration request.

The Sidelink configuration request may include one or more of the following:

(1) The position information of the reference terminal.

(2) The ID of the reference terminal.

(3) The PRS configuration information of the reference terminal.

(4) The configuration ID list of the reference terminal.

(5) The PRS configuration information of the target terminal.

(6) The configuration ID list of the target terminal.

(7) The request for requesting the number of the reference terminal.

(8) The request for requesting the position information of the reference terminal.

(9) The request for requesting the ID of the reference terminal.

(10) The request for requesting the PRS configuration information of the reference terminal.

(11) The request for requesting the configuration ID list of the reference terminal.

The PRS configuration information of the reference terminal may include at least one of the following:

(1) The PRS transmission frequency of the reference terminal.

(2) The PRS type of the reference terminal.

(3) The PRS transmission periodicity of the reference terminal.

(4) The number of symbols within the PRS transmission periodicity of the reference terminal.

(5) The gap between the symbols within the PRS transmission periodicity of the reference terminal.

(6) The number of the PRS transmission periodicity of the reference terminal.

(7) The PRS transmission bandwidth of the reference terminal.

(8) The number of repetitions within the PRS transmission bandwidth of the reference terminal.

(9) The PRS transmission start time and duration time of the reference terminal.

(10) The PRS transmission comb-type size in the frequency domain of the reference terminal.

The PRS configuration information of the target terminal includes at least one of the following:

(1) The PRS transmission frequency of the target terminal.

(2) The PRS type of the target terminal.

(3) The PRS transmission periodicity of the target terminal.

(4) The number of symbols within the PRS transmission periodicity of the target terminal.

(5) The gap between the symbols within the PRS transmission periodicity of the target terminal.

(6) The number of the PRS transmission periodicity of the target terminal.

(7) The PRS transmission bandwidth of the target terminal.

(8) The number of repetitions within the PRS transmission bandwidth of the target terminal.

(9) The PRS transmission start time and duration time of the target terminal.

(10) The PRS transmission comb-type size in the frequency domain of the target terminal.

Step 704-1′: The second base station transmits Sidelink positioning configuration to the reference terminal.

Step 704-2′: The reference terminal transmits the RRC Reconfig Complete message to the second base station.

Step 704-3: The second base station transmits a Sidelink configuration response to the first base station.

For example, the second base station transmits the second response to the first base station, and the second response is the Sidelink configuration response.

The Sidelink positioning configuration may include at least one of the following:

(1) The position information of the reference terminal.

(2) The ID of the reference terminal.

(3) The PRS configuration information of the reference terminal.

(4) The configuration ID list of the reference terminal.

(5) The failure information corresponding to the second request.

For example, the failure information may include at least one of the following:

(1) at least one parameter included in the second request being incapable of being satisfied;

(2) at least one parameter included in the second request being incapable of being satisfied, and an allowable range of values for the parameter being incapable of being satisfied; and

(3) the second network side device not supporting the second request.

Step 705-1: The first base station transmits a Sidelink positioning configuration request response to the target terminal.

Step 705-2: The target terminal transmits the RRC Reconfig Complete message to the first base station.

Step 706-1: The target terminal measures the PRS of the reference terminal.

For example, the target terminal measures, according to the received first PRS configuration information and/or first PRS transmission resource, the PRS of the reference terminal.

Step 706-2′: The reference terminal measures the PRS of the target terminal.

For example, the reference terminal measures, according to the received first PRS configuration information and/or first PRS transmission resource, the PRS of the target terminal.

It is to be noted that step 706-2′ is indicated by a dashed box in the figure.

In a case that step 706-2′ is selected to be executed, the following step 707′ is required;
in a case that step 706-2′ is not selected to be executed, that is, only step 706-1 is executed, step 707′ is not required.

Step 707′: In a case that the reference terminal measures the PRS of the target terminal, the reference terminal transmits the PRS measurement result to the target terminal.

It is to be noted that step 707′ is indicated by a dashed arrow in the figure.

Step 708: The target terminal calculates its own positioning result based on the PRS measurement result.

In embodiments of this application, since the first PRS configuration information and/or the first PRS transmission resource requested by the target terminal are/is used by the target terminal for Sidelink positioning, the received first PRS configuration information and/or first PRS transmission resource satisfy/satisfies positioning requirements of the target terminal, and the target terminal carries out positioning based on the first PRS configuration information and/or the first PRS transmission resource satisfying the positioning requirements of the target terminal, such that the positioning accuracy of Sidelink by the target terminal can be effectively improved.

It is to be noted that in a case that the serving cell of the reference terminal is the first base station, instead of executing the above steps 704-0, step 704-1′, step 704-2′, and step 704-3, step 704-1 and step 704-2 are directly executed, where steps 704-1 and step 704-2 are substantially the same as the above steps 604-1 and step 604-2, and instead of executing step 706-2′ and step 707′, step 706-2 and step 707 are directly executed, where step 706-2 and step 707 are substantially the same as the above step 606-2 and step 607 and will not be repeated herein.

In the positioning configuration information request method provided by the embodiments of this application, an executing body may be a positioning configuration information request apparatus. In the embodiments of this application, a positioning configuration information request apparatus executing a positioning configuration information request method is used as an example to illustrate the positioning configuration information request apparatus provided by an embodiment of this application.

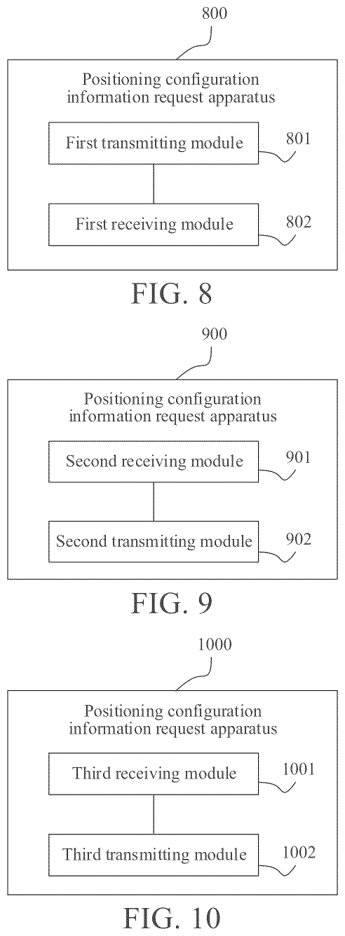

FIG. 8 is a first schematic structural diagram of a positioning configuration information request apparatus provided by an embodiment of this application. As shown in FIG. 8, the positioning configuration information request apparatus 800 is applied to a target terminal and includes:
a first transmitting module 801, configured to transmit a first request to a first network side device, where the first request is used for requesting the first network side device to configure first PRS configuration information and/or a first PRS transmission resource, and the first PRS configuration information and/or the first PRS transmission resource are/is used for Sidelink positioning; and
a first receiving module 802, configured to receive a first response from the first network side device, where the first response includes the first PRS configuration information and/or the first PRS transmission resource.

In the positioning configuration information request apparatus provided by the embodiment of this application, since the first PRS configuration information and/or the first PRS transmission resource requested by the target terminal by means of the first transmitting module are/is used by the target terminal for Sidelink positioning, the first PRS configuration information and/or the first PRS transmission resource received by the first receiving module satisfy/satisfies positioning requirements of the target terminal, and the target terminal carries out positioning based on the first PRS configuration information and/or the first PRS transmission resource satisfying the positioning requirements of the target terminal, such that the positioning accuracy of the target terminal for Sidelink can be effectively improved.

FIG. 9 is a second schematic structural diagram of a positioning configuration information request apparatus provided by an embodiment of this application. As shown in FIG. 9, the positioning configuration information request apparatus 900 is applied to a first network side device and includes:
a second receiving module 901, configured to receive a first request from a target terminal, where the first request is used for requesting the first network side device to configure first PRS configuration information and/or a first PRS transmission resource, and the first PRS configuration information and/or the first PRS transmission resource are/is used for Sidelink positioning; and
a second transmitting module 902, configured to transmit a first response to the target terminal based the first request, where the first response includes the first PRS configuration information and/or the first PRS transmission resource.

In the positioning configuration information request apparatus provided by the embodiment of this application, since the first PRS configuration information and/or the first PRS transmission resource in the first request received by the second receiving module of the first network side device are/is requested by the target terminal for Sidelink positioning, the first PRS configuration information and/or the first PRS transmission resource transmitted to the target terminal by means of the second transmitting module satisfy/satisfies positioning requirements of the target terminal, and the target terminal carries out positioning based on the first PRS configuration information and/or the first PRS transmission resource satisfying the positioning requirements of the target terminal, such that the positioning accuracy of the target terminal for Sidelink can be effectively improved.

FIG. 10 is a third schematic structural diagram of a positioning configuration information request apparatus provided by an embodiment of this application. As shown in FIG. 10, the positioning configuration information request apparatus 1000 is applied to a second network side device and includes:
a third receiving module 1001, configured to receive a second request from a first network side device, where the second request is used for requesting the second network side device to configure second PRS configuration information and/or a second PRS transmission resource, and the second PRS configuration information and/or the second PRS transmission resource are/is used for Sidelink positioning; and
a third transmitting module 1002, configured to transmit a second response to the first network side device based on the second request, where the second response includes the second PRS configuration information and/or the second PRS transmission resource.

In the positioning configuration information request apparatus provided by the embodiment of this application, in a case that a serving cell of the reference terminal is not the same cell as a serving cell of the target terminal, the first network side device transmits the second request to the second network side device to which the reference terminal accesses, requesting the second network side device to configure the second PRS configuration information and/or the second PRS transmission resource for Sidelink positioning, so that the target terminal and/or the reference terminal can obtain PRS configuration and a Sidelink resource that satisfy the positioning accuracy requirement of the target terminal for Sidelink, and the positioning accuracy of the target terminal for Sidelink can be effectively improved.

The positioning configuration information request apparatus in the embodiment of this application may be an electronic device, such as an electronic device with an operating system, or a component in the electronic device, such as an integrated circuit or a chip. The electronic device may be a terminal or may be other devices other than the terminal. For example, the electronic device may be a mobile phone, a tablet computer, a notebook computer, a palmtop computer, a vehicle-mounted electronic device, a MID, an AR/VR device, a robot, a wearable device, an UMPC, a netbook, a PDA, and the like, and may also be a server, a Network Attached Storage (NAS), a PC, a Television (TV), a teller machine, or a self-service machine, which is not specifically limited in the embodiment of this application. Exemplarily, the terminal may include, but not limited to the type of the terminal 11 illustrated above, and other devices may be a server, an NAS and the like, which is not specifically limited in the embodiment of this application.

The positioning configuration information request apparatus in the embodiment of this application may be an apparatus with an operating system. The operating system may be an Android operating system, may be an iOS operating system, or may be another possible operating system, and is not specifically limited in the embodiment of this application.

The positioning configuration information request apparatus provided by the embodiment of this application can implement all processes implemented by the method embodiments of FIG. 2 to FIG. 7, and the same technical effect can be achieved, details of which are omitted here for brevity.

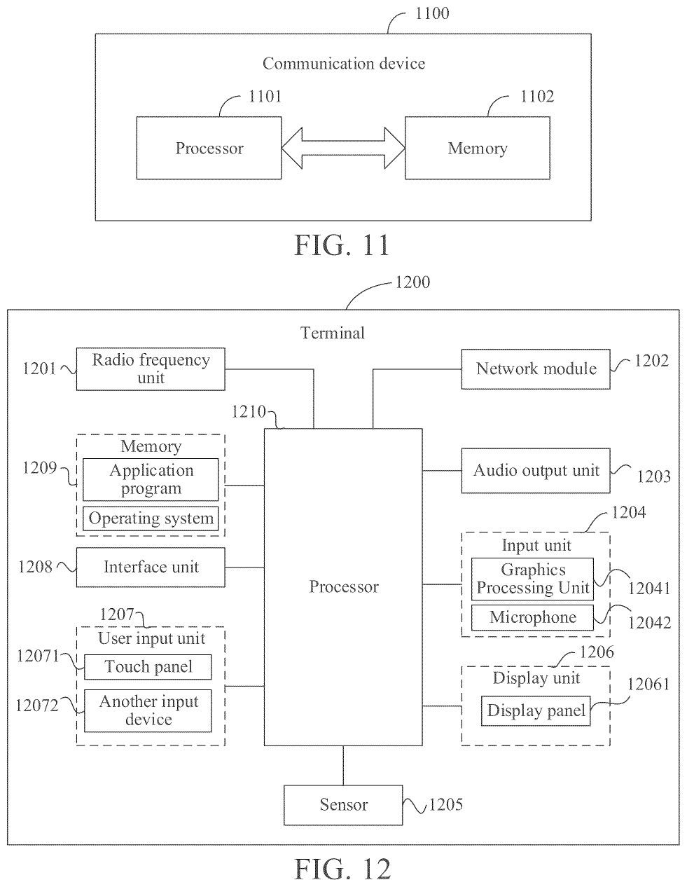

FIG. 11 is a schematic structural diagram of a communication device provided by an embodiment of this application. As shown in FIG. 11, the communication device 1100 includes a processor 1101 and a memory 1102. A program or instruction runnable on the processor 1101 is stored on the memory 1102. For example, when the communication device 1100 is a target terminal, the program or instruction, when executed by the processor 1101, implements various steps of the above positioning configuration information request method embodiment on a target terminal side, and the same technical effect can be achieved. When the communication device 1100 is a first network side device, the program or instruction, when executed by the processor 1101, implements various steps of the above positioning configuration information request method embodiment on a first network side device side, and the same technical effect can be achieved. When the communication device 1100 is a second network side device, the program or instruction, when executed by the processor 1101, implements various steps of the above positioning configuration information request method embodiment on a second network side device side, and the same technical effect can be achieved, details of which are omitted here for brevity.

An embodiment of this application further provides a target terminal, including a processor and a communication interface. The communication interface is configured to transmit a first request to a first network side device, where the first request is used for requesting the first network side device to configure first PRS configuration information and/or a first PRS transmission resource, and the first PRS configuration information and/or the first PRS transmission resource are/is used for Sidelink positioning; and the communication interface is further configured to receive a first response from the first network side device, where the first response includes the first PRS configuration information and/or the first PRS transmission resource. The target terminal embodiment corresponds the above target terminal side method embodiment, each implementation process and implementation manner of the above method embodiment is applicable in the target terminal embodiment, and the same technical effect can be achieved.

FIG. 12 is a schematic structural diagram of a target terminal provided by an embodiment of this application. As shown in FIG. 12, the target terminal 1200 includes, but not limited to: at least part of components such as a radio frequency unit 1201, a network module 1202, an audio output unit 1203, an input unit 1204, a sensor 1205, a display unit 1206, a user input unit 1207, an interface unit 1208, a memory 1209 and a processor 1210.

It will be appreciated by those skilled in the art that the target terminal 1200 may further include a power supply (such as a battery) for supplying power to each component, and the power supply may be logically connected to the processor 1210 by means of a power management system, thereby implementing functions such as charging, discharging, and power consumption management by means of the power management system. The terminal structure shown in FIG. 12 does not constitute a limitation on the terminal, and the terminal may include components more or fewer than components shown in the figure, or combine some components, or have different component arrangements, which will not be described in detail here.

It is to be understood that, in the embodiment of this application, the input unit 1204 may include a Graphics Processing Unit (GPU) 12041 and a microphone 12042. The GPU 12041 performs processing on image data of a static picture or a video that is obtained by an image acquisition device (for example, a camera) in a video acquisition mode or an image acquisition mode. The display unit 1206 may include a display panel 12061. The display panel 12061 may be configured in the form of a liquid crystal display, an organic light-emitting diode, or the like. The user input unit 1207 includes at least one of a touch panel 12071 and another input device 12072. The touch panel 12071 is also called a touchscreen. The touch panel 12071 may include two parts: a touch detection apparatus and a touch controller. The another input device 12072 may include, but is not limited to, a physical keyboard, a functional key (such as a volume control key or a switch key or the like), a track ball, a mouse, and a joystick, which will not be described in detail here.

In the embodiment of this application, after downlink data from a network side device is received by the radio frequency unit 1201, the downlink data may be transmitted to the processor 1210 for processing. In addition, the radio frequency unit 1201 may transmit uplink data to the network side device. Generally, the radio frequency unit 1201 includes, but not limited to, an antenna, an amplifier, a transceiver, a coupler, a low noise amplifier, a duplexer, and the like.

The memory 1209 may be configured to store a software program or instruction and various data. The memory 1209 may mainly include a first storage area for storing a program or instruction and a second storage area storing data, where the first storage area may store an operating system, an application program or instruction required by at least one function (for example, a sound playback function and an image display function), and the like. In addition, the memory 1209 may include a volatile memory or a non-volatile memory, or the memory 1209 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1209 in the embodiment of this application includes, but not limited to, these memories and any other suitable types of memories.

The processor 1210 may include one or more processing units. In some embodiments, the processor 1210 integrates an application processor and a modem processor, where the application processor mainly processes operations relating to an operating system, a user interface, an application program, and the like, and the modem processor, such as a baseband processor, mainly processes a wireless communication signal. It will be appreciated that the above modem processor may not be integrated into the processor 1210.

The radio frequency unit 1201 is configured to transmit a first request to a first network side device, where the first request is used for requesting the first network side device to configure first PRS configuration information and/or a first PRS transmission resource, and the first PRS configuration information and/or the first PRS transmission resource are/is used for Sidelink positioning.

The radio frequency unit 1201 is further configured to receive a first response from the first network side device, where the first response includes the first PRS configuration information and/or the first PRS transmission resource.

In embodiments of this application, since the first PRS configuration information and/or the first PRS transmission resource requested by the target terminal are/is used by the target terminal for Sidelink positioning, the received first PRS configuration information and/or first PRS transmission resource satisfy/satisfies positioning requirements of the target terminal, and the target terminal carries out positioning based on the first PRS configuration information and/or the first PRS transmission resource satisfying the positioning requirements of the target terminal, such that the positioning accuracy of Sidelink by the target terminal can be effectively improved.

In some embodiments, the radio frequency unit 1201 is further configured to transmit a first activation request to the first network side device in a case that a PRS transmission activation indication of the reference terminal is used for indicating that PRS transmission of the reference terminal needs to be activated, where the first activation request is used for requesting to activate the PRS transmission of the reference terminal.
and/or
to transmit a second activation request to the first network side device in a case that a PRS transmission activation indication of the target terminal is used for indicating that PRS transmission of the target terminal needs to be activated, where the second activation request is used for requesting to activate the PRS transmission of the target terminal.

In some embodiments, the radio frequency unit 1201 is further configured to receive, before the first request is transmitted to the first network side device, a first indication from the first network side device. The first indication is used for indicating that the first network side device allows the target terminal to transmit the first request.

In some embodiments, the radio frequency unit 1201 is further configured to measure, after the first response from the first network side device is received, the PRS of the reference terminal based on the first response to obtain a first PRS measurement result, and to calculate a positioning result of the target terminal based on the first PRS measurement result.

In some embodiments, the radio frequency unit 1201 is further configured to receive a second PRS measurement result from the reference terminal, where the second PRS measurement result is a measurement result obtained by the reference terminal measuring, based on the first response, a PRS of the target terminal, and to calculate the positioning result of the target terminal based on the first PRS measurement result and the second PRS measurement result.

An embodiment of this application further provides a first network side device, including a processor and a communication interface. The communication interface is configured receive a first request from a target terminal, where the first request is used for requesting the first network side device to configure first PRS configuration information and/or a first PRS transmission resource, and the first PRS configuration information and/or the first PRS transmission resource are/is used for Sidelink positioning; and the communication interface is further configured to transmit a first response to the target terminal based on the first request, and the first response includes the first PRS configuration information and/or the first PRS transmission resource. The first network side device embodiment corresponds to the above first network side device method embodiment, each implementation process and implementation manner of the above method embodiment are applicable in the first network side device embodiment, and the same technical effect can be achieved.

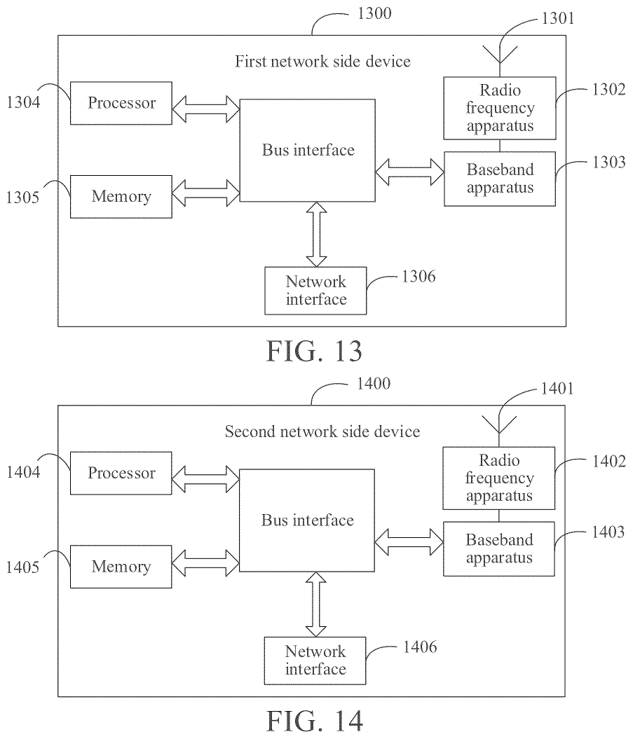

FIG. 13 is a schematic structural diagram of a first network side device provided by an embodiment of this application. As shown in FIG. 13, the first network side device 1300 includes: an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information via the antenna 1301 and transmits the received information to the baseband apparatus 1303 for processing. In a downlink direction, the baseband apparatus 1303 processes information to be transmitted and transmits same to the radio frequency apparatus 1302, and the radio frequency apparatus 1302 processes the received information and then transmits it out by means of the antenna 1301.

The method executed by the network side device in the above embodiment may be implemented in the baseband apparatus 1303, and the baseband apparatus 1303 includes a baseband processor.

The baseband apparatus 1303 may, for example, include at least one baseband board which is provided with a plurality of chips, as shown in FIG. 13, one of the chips is, for example, a baseband processor, and is connected to the memory 1305 via a bus interface to call a program in the memory 1305 to execute operations of a network device as shown in the above method embodiment.

The network side device may further include a network interface 1306, and the interface is for example a Common Public Radio Interface (CPRI).

For example, the first network side device 1300 of the embodiment of this application further includes: instructions or programs stored on the memory 1305 and runnable on the processor 1304, where the processor 1304 calls the instruction or program in the memory 1305 to execute the positioning configuration information request method as described above, and the same technical effect can be achieved, details of which are omitted here for brevity.

An embodiment of this application further provides a second network side device, including a processor and a communication interface. The communication interface is configured to receive a second request from a first network side device, where the second request is used for requesting the second network side device to configure second PRS configuration information and/or a second PRS transmission resource, and the second PRS configuration information and/or the second PRS transmission resource are/is used for Sidelink positioning; and the communication interface is further configured to transmit a second response to the first network side device based on the second request, where the second response includes the second PRS configuration information and/or the second PRS transmission resource. The second network side device embodiment corresponds to the above second network side device method embodiment, each implementation process and implementation manner of the above method embodiment are applicable in the second network side device embodiment, and the same technical effect can be achieved.

FIG. 14 is a schematic structural diagram of a second network side device provided by an embodiment of this application. As shown in FIG. 14, the second network side device 1400 includes: an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information via the antenna 1401 and transmits the received information to the baseband apparatus 1403 for processing. In a downlink direction, the baseband apparatus 1403 processes information to be transmitted and transmits same to the radio frequency apparatus 1402, and the radio frequency apparatus 1402 processes the received information and then transmits it out by means of the antenna 1401.

The method executed by the network side device in the above embodiment may be implemented in the baseband apparatus 1403, and the baseband apparatus 1403 includes a baseband processor.

The baseband apparatus 1403 may, for example, include at least one baseband board which is provided with a plurality of chips, as shown in FIG. 14, one of the chips is, for example, a baseband processor, and is connected to the memory 1405 via a bus interface to call a program in the memory 1405 to execute operations of a network device as shown in the above method embodiment.

The network side device may further include a network interface 1406, and the interface is for example the CPRI.

For example, the second network side device 1400 of the embodiment of this application further includes: instructions or programs stored on the memory 1405 and runnable on the processor 1404, where the processor 1404 calls the instruction or program in the memory 1405 to execute the positioning configuration information request method as described above, and the same technical effect can be achieved, details of which are omitted here for brevity.

An embodiment of this application further provides a positioning configuration information request system, including: a target terminal, a first network side device, and a second network side device, where the target terminal may be configured to execute steps of the positioning configuration information request method on the target terminal side as described above, the first network side device may be configured to execute steps of the positioning configuration information request method on the first network side device side as described above, and the second network side device may be configured to execute steps of the positioning configuration information request method on a second network side device side as described above.

An embodiment of this application further provides a readable storage medium, where the readable storage medium may be volatile or non-volatile, a program or instruction is stored on the readable storage medium, the program or instruction, when executed by a processor, implements various processes of the above positioning configuration information request method embodiment, and the same technical effect can be achieved, details of which are omitted here for brevity.

The processor is a processor in the terminal in the above embodiment. The readable storage medium includes a computer-readable storage medium, such as, a computer ROM, the RAM, a magnetic disk, an optical disc or the like.

An embodiment of this application further provides a chip, where the chip includes a processor and a communication interface, the communication interface is coupled to the processor, the processor is configured to run a program or instruction to implement various processes of the above positioning configuration information request method embodiment, and the same technical effect can be achieved, details of which are omitted here for brevity.

It should be understood that the chip referred to in the embodiment of this application may also be referred to as a system-on-a-chip, a system-on-chip or a system on chip, etc.

An embodiment of this application further provides a computer program/program product, where the computer program/program product is stored in a storage medium, the computer program/program product is executed by at least one processor to implement various processes of the above positioning configuration information request method, and the same technical effect can be achieved, details of which are omitted here for brevity.

It is to be noted that the terms “include”, “contain”, or any other variants thereof in this specification are intended to cover a non-exclusive inclusion, such that a process, method, object, or apparatus including a set of elements includes not only those elements, but also other elements that are not expressly listed or elements that are inherent to such a process, method, object, or apparatus. Without more limitations, elements defined by the sentence “including one . . . ” does not exclude that there are still other same elements in the process, method, object, or apparatus including the element. Furthermore, it is to be noted that the scope of the method and apparatus in the implementation mode of this application is not limited to executing the functions in the order shown or discussed, but may also include executing the functions in a substantially same manner or in the reverse order according to the functions involved, for example, the described method may be executed in an order different from the order described, and various steps may also be added, omitted, or combined. In addition, features described with reference to some examples may also be combined in other examples.

According to the descriptions in the above implementation mode, a person skilled in the art may clearly learn that the method according to the above embodiment may be implemented by relying on software and an essential common hardware platform or, of course, by using hardware, however, in many cases, the former is a better implementation mode. On the basis of such an understanding, the technical solutions of this application essentially, or the part contributing to the related art, may be embodied in the form of a computer software product. The computer software product is stored in a storage medium (for example, ROM/RAM, a magnetic disk, and an optical disc) including several instructions to enable a terminal (which may be a mobile phone, a computer, a server, an air conditioner, a network device, or the like) to execute the methods described in the various embodiments of this application.

The embodiments of this application have been described above with reference to the accompanying drawings. However, this application is not limited to the above implementations, and the above implementations are merely exemplary and not limitative. Those of ordinary skill in the art may make various variations under the teaching of this application without departing from the spirit of this application and the protection scope of the claims, and such variations shall all fall within the protection scope of this application.

What is claimed is:

1. A positioning configuration information request method, comprising:
transmitting, by a target terminal, a first request to a first network side device, wherein the first request is used for requesting the first network side device to configure first Positioning Reference Signal (PRS) configuration information or a first PRS transmission resource, wherein the first PRS configuration information or the first PRS transmission resource is used for Sidelink positioning; and
receiving, by the target terminal, a first response from the first network side device, wherein the first response comprises the first PRS configuration information or the first PRS transmission resource.

2. The positioning configuration information request method according to claim 1, wherein the first request comprises at least one of the following:
a positioning Quality of Service (QoS) list of the target terminal;
a movement status of the target terminal;
a measurement result of the target terminal;
a request for requesting PRS configuration information of the target terminal;
a request for requesting a configuration identification (ID) list of the target terminal;
a request for requesting a number of a reference terminal;
a request for requesting position information of the reference terminal;
a request for requesting an ID of the reference terminal;
a request for requesting PRS configuration information of the reference terminal; or
a request for requesting a configuration ID list of the reference terminal.

3. The positioning configuration information request method according to claim 1, wherein the first PRS configuration information comprises at least one of the following:
the position information of the reference terminal;
the ID of the reference terminal;
the PRS configuration information of the reference terminal;
the configuration ID list of the reference terminal;
the PRS configuration information of the target terminal; or
the configuration ID list of the target terminal.

4. The positioning configuration information request method according to claim 1, wherein the first PRS transmission resource comprises at least one of the following:
a bandwidth of a PRS transmission resource;
initial frequency information of the PRS transmission resource;
start time of the PRS transmission resource;
termination time of the PRS transmission resource;
duration time of the PRS transmission resource;
a periodicity of the PRS transmission resource; or
an associated resource pool ID of the PRS transmission resource.

5. The positioning configuration information request method according to claim 1, wherein the first response further comprises at least one of the following:
a PRS transmission activation indication of the reference terminal, used for indicating whether PRS transmission of the reference terminal needs to be activated;
a PRS transmission activation indication of the target terminal, used for indicating whether PRS transmission of the target terminal needs to be activated; or
failure information corresponding to the first request.

6. The positioning configuration information request method according to claim 5, wherein:
when the PRS transmission activation indication of the reference terminal is used for indicating that the PRS transmission of the reference terminal needs to be activated, the method further comprises: transmitting, by the target terminal, a first activation request to the first network side device, wherein the first activation request is used for requesting to activate the PRS transmission of the reference terminal;
or
when the PRS transmission activation indication of the target terminal is used for indicating that the PRS transmission of the target terminal needs to be activated, the method further comprises: transmitting, by the target terminal, a second activation request to the first network side device, wherein the second activation request is used for requesting to activate the PRS transmission of the target terminal.

7. The positioning configuration information request method according to claim 6, wherein the activation request comprises Medium Access Control-Control Element (MAC CE), or Uplink Control Information (UCI).

8. The positioning configuration information request method according to claim 5, wherein the failure information comprises at least one of the following:
at least one parameter comprised in the first request being incapable of being satisfied;
at least one parameter comprised in the first request being incapable of being satisfied, or an allowable range of values for the parameter that is incapable of being satisfied; or
the first network side device not supporting the first request.

9. The positioning configuration information request method according to claim 1, wherein before transmitting, by the target terminal, the first request to the first network side device, the method further comprises:
receiving, by the target terminal, a first indication from the first network side device, wherein the first indication is used for indicating that the first network side device allows the target terminal to transmit the first request.

10. The positioning configuration information request method according to claim 9, wherein the first indication comprises at least one of the following:
allowing the target terminal to transmit the first request;
duration of a first timer;
a number of a reference terminal that is capable of requesting configuration;
PRS configuration information of the reference terminal that is capable of requesting configuration;
a configuration list of the reference terminal that is capable of requesting configuration, wherein the configuration list of the reference terminal comprises: a configuration ID of the reference terminal, or PRS configuration information of the reference terminal;
PRS configuration information of a target terminal that is capable of requesting configuration; or
a configuration list of the target terminal that is capable of requesting configuration, wherein the configuration list of the target terminal comprises: a configuration ID of the target terminal, or PRS configuration information of the target terminal.

11. The positioning configuration information request method according to claim 9, wherein the first indication is carried in a broadcast message or a dedicated message.

12. The positioning configuration information request method according to claim 1, wherein the PRS configuration information of the reference terminal comprises at least one of the following:
a PRS transmission frequency of the reference terminal;
a PRS type of the reference terminal;
a PRS transmission periodicity of the reference terminal;
the number of symbols within the PRS transmission periodicity of the reference terminal;
gap between the symbols within the PRS transmission periodicity of the reference terminal;
the number of the PRS transmission periodicity of the reference terminal;
a PRS transmission bandwidth of the reference terminal;
the number of repetitions within the PRS transmission bandwidth of the reference terminal;
PRS transmission start time and duration time of the reference terminal; or
a PRS transmission comb-type size in the frequency domain of the reference terminal.

13. The positioning configuration information request method according to claim 1, wherein the PRS configuration information of the target terminal comprises at least one of the following:
a PRS transmission frequency of the target terminal;
a PRS type of the target terminal;
a PRS transmission periodicity of the target terminal;
the number of symbols within the PRS transmission periodicity of the target terminal;
gap between the symbols within the PRS transmission periodicity of the target terminal;
the number of the PRS transmission periodicity of the target terminal;
a PRS transmission bandwidth of the target terminal;
the number of repetitions within the PRS transmission bandwidth of the target terminal;
PRS transmission start time and duration time of the target terminal; or
a PRS transmission comb-type size in the frequency domain of the target terminal.

14. The positioning configuration information request method according to claim 1, wherein after receiving, by the target terminal, the first response from the first network side device, the method further comprises:
measuring, by the target terminal, a PRS of the reference terminal based on the first response to obtain a first PRS measurement result; and
calculating, by the target terminal, a positioning result of the target terminal based on the first PRS measurement result.

15. A positioning configuration information request method, comprising:
receiving, by a first network side device, a first request from a target terminal, wherein the first request is used for requesting the first network side device to configure first PRS configuration information or a first PRS transmission resource, wherein the first PRS configuration information or the first PRS transmission resource is used for Sidelink positioning; and
transmitting, by the first network side device, a first response to the target terminal based on the first request, wherein the first response comprises the first PRS configuration information or the first PRS transmission resource.

16. The positioning configuration information request method according to claim 15, wherein the first request comprises at least one of the following:
a positioning Quality of Service (QoS) list of the target terminal;
a movement status of the target terminal;
a measurement result of the target terminal;
a request for requesting PRS configuration information of the target terminal;
a request for requesting a configuration ID list of the target terminal;
a request for requesting a number of a reference terminal;
a request for requesting position information of the reference terminal;
a request for requesting an ID of the reference terminal;
a request for requesting PRS configuration information of the reference terminal; or
a request for requesting a configuration ID list of the reference terminal.

17. The positioning configuration information request method according to claim 15, wherein the first PRS transmission resource comprises at least one of the following:
a bandwidth of a PRS transmission resource;
initial frequency information of the PRS transmission resource;
start time of the PRS transmission resource;
termination time of the PRS transmission resource;
duration time of the PRS transmission resource;
a periodicity of the PRS transmission resource; or
an associated resource pool ID of the PRS transmission resource.

18. The positioning configuration information request method according to claim 15, wherein before receiving, by the first network side device, the first request from the target terminal, the method further comprises:
transmitting, by the first network side device, a first indication to the target terminal, wherein the first indication is used for indicating that the first network side device allows the target terminal to transmit the first request.

19. The positioning configuration information request method according to claim 15, wherein the PRS configuration information of the target terminal comprises at least one of the following:
a PRS transmission frequency of the target terminal;
a PRS type of the target terminal;
a PRS transmission periodicity of the target terminal;
the number of symbols within the PRS transmission periodicity of the target terminal;
gap between the symbols within the PRS transmission periodicity of the target terminal;
the number of the PRS transmission periodicity of the target terminal;
a PRS transmission bandwidth of the target terminal;
the number of repetitions within the PRS transmission bandwidth of the target terminal;
PRS transmission start time and duration time of the target terminal; or
a PRS transmission comb-type size in the frequency domain of the target terminal.

20. A terminal, comprising: a processor; and a memory having a computer program or an instruction stored thereon, wherein the computer program or an instruction, when executed by the processor, causes the processor to perform operations comprising:
transmitting a first request to a first network side device, wherein the first request is used for requesting the first network side device to configure first Positioning Reference Signal (PRS) configuration information or a first PRS transmission resource, wherein the first PRS configuration information or the first PRS transmission resource is used for Sidelink positioning; and
receiving a first response from the first network side device, wherein the first response comprises the first PRS configuration information or the first PRS transmission resource.
